(19) United States
(12) Patent Application Publication
(10) Pub. No.: US 2023/0417221 A1
(43) Pub. Date: Dec. 28, 2023

(54) TEXTILE MACHINE HAVING AN ENERGY RECOVERY DEVICE

(71) Applicant: Saurer Spinning Solutions GmbH & Co. KG, Uebach-Palenberg (DE)

(72) Inventors: Michael SPITZER, Monschau-Kalterherberg (DE); Sebastian THOMAS, Moenchengladbach (DE)

(21) Appl. No.: 18/338,748

(22) Filed: Jun. 21, 2023

(30) Foreign Application Priority Data
Jun. 23, 2022 (LU) LU502348

(51) Int. Cl. F03D 9/30; D01H 1/14

(52) U.S. Cl. CPC F03D 9/30; D01H 1/14; F05B 2220/602

(57) ABSTRACT

A textile machine comprising a plurality of workstations for processing fibres and/or threads; at least one unit through which air flows, located centrally and/or at the individual workstations; and an energy recovery device. In order to provide a textile machine having an energy recovery device which has high energy efficiency, the energy recovery device has a rotational element which: can be fluidically connected to a supply air line and/or exhaust air line of the unit; can be driven by an air flow; and is connected to a generator for electricity generation.

### CROSS-REFERENCE TO RELATED APPLICATION

This claims priority from Luxembourg Application No. LU502348, filed Jun. 23, 2022, the disclosure of which is hereby incorporated by reference in its entirety.

### FIELD OF THE INVENTION

The present invention relates to a textile machine having a plurality of workstations for processing fibres and/or threads and having at least one unit through which air flows, located centrally and/or at the individual workstations. The present invention also relates to an energy recovery device for a textile machine for processing fibres and/or threads, the textile machine having a plurality of workstations.

### BACKGROUND OF THE INVENTION

In the context of the present invention, the term “textile machines” is understood to mean machines which are used in the production of a thread from fibres in the various production steps. Such machines are, for example, textile machines that produce cross-wound packages, such as open-end rotor spinning machines, air-spinning machines or automatic winding machines.

Depending on their intended use, textile machines of this kind have a number of different units, which have various tasks within the different processes in the production of the thread. Many of these units use an air flow for their function. These units through which air flows can be central units arranged on the textile machine or units present at the individual workstations. Such units at the workstations can be, for example, spinning devices which require a negative spinning pressure or suction nozzles by means of which a thread can be retrieved from a cross-wound package and provided for piecing up. A suction system for producing the required negative pressure is often in the form of a central unit or at least assigned to a group of workstations. Likewise, compressed-air sources are often central units which, for example, supply compressed air to cleaning nozzles or spinning nozzles at the workstations.

A considerable amount of energy is required to produce a positive pressure or negative pressure in the units through which air flows, and this energy is only partially used during the functional process. A large part of the energy converted into compressed air or negative pressure is not used and is lost.

### SUMMARY OF THE INVENTION

Proceeding therefrom, a problem addressed herein is that of providing a textile machine which has high energy efficiency.

An embodiment of the present invention solves the problem by a textile machine having a plurality of workstations for processing fibres and/or threads, the textile machine comprising at least one unit through which air flows, located centrally and/or at the individual workstations, wherein an energy recovery device is arranged in a supply air line and/or exhaust air line of the unit.

The textile machine according to an embodiment of the present invention is characterised in that, by the energy recovery device, the textile machine utilises unused air flow fed to and discharged from the individual units to generate electrical energy. The textile machine according to an embodiment of the present invention has higher efficiency than conventional textile machines lacking an energy recovery device. By appropriate electrical components, the electrical energy can be returned, e.g. to the textile machine, or can be used to charge an energy store.

The energy recovery device of the textile machine according to an embodiment of the present invention is characterised by a rotational element which: can be fluidically connected to a supply air line and/or exhaust air line of a unit through which air flows and which belongs to the textile machine or the workstation; can be driven by an air flow; and is connected to a generator for electricity generation.

The energy recovery device is designed to be connected to the supply air line and/or exhaust air line of a unit through which air flows. The air flow flowing through the unit drives the rotational element of the energy recovery device. With the aid of the connection of the rotational element to the generator, the rotational motion of the rotational element is used to generate electricity.

The energy recovery device of the textile machine according to an embodiment of the present invention can be arranged in the supply air line as well as in the exhaust air line, in which, depending on the particular unit of the textile machine, there is a negative pressure or positive pressure which produces an air flow. The air flow is used primarily for the function of the unit. The air flow flowing through the unit is also used to drive the rotational element connected to the generator, so that the unused air flow is converted into electrical energy. This electrical energy can, for example, be fed back into the textile machine, be fed into a central company network or be used to charge an energy store.

The textile machine according to an embodiment of the present invention with the energy recovery device thus allows the unused kinetic energy of the air flow to be converted into usable energy. The energy recovery device thus increases the efficiency of a textile machine designed accordingly.

In principle, the arrangement of the rotational element in the supply air line and/or exhaust air line of the unit, e.g. suction system, can be freely selected. According to an embodiment of the present invention, however, the energy recovery device has a housing body which can be connected to an exhaust air line of the unit and which has a flow cross-section which widens from a housing inlet up to a housing outlet. In this embodiment of the present invention, the housing body of the energy recovery device is designed in the manner of a diffuser, wherein the opening cross-section of the housing body through which the air flow flows widens in the flow direction. As a result, in certain regions of the flow cross-section the flow velocity can be increased and the static pressure decreased, so that in the certain regions of the flow cross-section the air flow can be converted into electrical energy by the rotational element particularly efficiently. Furthermore, when, according to an embodiment, the rotational element is arranged in the region of the housing outlet, the use of a housing body ensures to an additional extent that the rotational element has a small influence on the air flow through the unit, so that interference with the function of the unit due to the arrangement of the energy recovery device can be particularly reliably avoided.

In principle, one can freely select the orientation of the axis of rotation of the rotational element, which in principle can be any element that can be set in rotation by an air flow, e.g. a blade wheel. Thus, the rotational element can be arranged in the air flow in such a way that the axis of rotation of the rotational element is oriented perpendicularly or parallel to the longitudinal axis of the housing body. According to an embodiment of the present invention, however, the axis of rotation of the rotational element extends in a plane which does not run perpendicularly or parallel to the longitudinal axis of the housing body. It can be provided that the axis of rotation is arranged in such a way that it is oriented independently by the air flow or is oriented by control.

This embodiment of the invention ensures—in particular when, advantageously, a housing body having a widening flow cross-section is used—that the rotational element is optimally oriented relative to the air flow arising in the housing body, whereby the efficiency of the energy recovery by the generator connected to the rotational element can be increased further. The independent orienting of the axis of rotation relative to the air flow can be accomplished e.g. by corresponding flexible support of the axis of rotation on the housing body. Controlled orienting of the axis of rotation can be accomplished by an actuating drive in conjunction with a sensor.

According to another embodiment of the present invention, the housing body has a guide plate, which extends in the region between the housing inlet and the housing outlet and divides the air flow through the housing body, and the rotational element is arranged in the region between the guide plate and a housing wall of the housing body. In this embodiment of the present invention, with the aid of a guide plate a defined part of the air flow supplied from the unit is used to drive the rotational element. This embodiment of the present invention particularly reliably ensures that the energy recovery does not result in impairment of the function of the unit through which air flows and which belongs to the textile machine and/or the workstation. The guide plate, which can be arranged parallel to a housing wall of the housing body, can directly adjoin the housing inlet and the housing outlet or can extend only over a partial region between the housing inlet and the housing outlet.

According to another embodiment of the present invention, the housing wall has an opening and the rotational element is arranged on the outside of the housing body in the region of the opening in such a way that an air flow flowing through the housing body produces a suction flow which drives the rotational element.

In this embodiment of the present invention, the rotational element is not arranged in the direct air flow but rather is arranged on the outside in the region of the housing opening in such a way that the rotational element is driven by the suction flow produced in the region of the housing opening as a result of the air flowing through the housing. In this embodiment of the present invention, the rotational element can be easily accessed when maintenance work or repair work is required. Furthermore, it is advantageously provided that the opening size can be adjusted, so that the suction flow acting on the rotational element can be easily varied by such adjustment and thus the energy recovery can be controlled. This embodiment of the present invention also particularly reliably ensures that the energy recovery device does not result in impairment of the function of the units through which air flows.

According to a further embodiment of the present invention, the energy recovery device or a housing body of the energy recovery device is designed to be integrated into a feed line, and can be integrated into a compressed-air line leading to the unit. In this embodiment of the present invention, the compressed-air flow is converted into electrical energy even before the compressed air is fed into the unit through which air flows and which belongs to the textile machine and/or to the individual workstations. This embodiment of the present invention ensures particularly high efficiency of the energy recovery; by an adjustable connection of the rotational element to the generator, the magnitude of the energy recovery and thus the proportion of the utilised compressed air for the energy recovery can be set. Thus, in the case of increased demand for compressed air, this embodiment of the present invention allows the energy recovery by the rotational element to be reduced so that reliable functioning of the compressed-air-driven units through which air flows is ensured.

According to an embodiment of the present invention, in the case of integration of the energy recovery device into a feed line a further development of the present invention provides that the energy recovery device or the housing body of the energy recovery device is arranged in the region of an outlet of a compressed-air-generating device, and can be in the region of the outlet of a spiral housing of a compressed-air-generating fan wheel. A corresponding arrangement particularly reliably ensures that the generation of compressed air by the fan wheel is not influenced by the energy recovery device, in order to particularly reliably ensure the supply to the units through which air flows.

According to another embodiment of the textile machine according to the present invention, the supply air line and/or exhaust air line which belongs to the unit and in which the energy recovery device is arranged is in the form of a duct extending in the longitudinal direction of the textile machine. Such ducts are well known and can extend over the entire length of the textile machine. The ducts can be the supply air line or exhaust air line of a central unit, and can be of a suction system or of a compressed-air-generating device. The ducts running the length of the machine can supply the units of the workstations with negative pressure or compressed air. The ducts are suitable for the arrangement of one or more energy recovery devices, because they have particularly large air flow rate.

### BRIEF DESCRIPTION OF THE DRAWINGS

Embodiment examples of the present invention are explained below with reference to the drawing. In the drawings:

FIG. 1 shows a schematic perspective illustration of an energy recovery device having a rotational element in the form of a blade wheel;

FIG. 2 shows a schematic perspective illustration of a first embodiment of a housing body for arranging on an exhaust air line of a unit through which air flows;

FIG. 3 shows a schematic side-view illustration of the housing body of FIG. 2 with a rotational element of an energy recovery device;

FIG. 4 shows a schematic illustration of a second embodiment of a housing body with a rotational element;

FIG. 5 shows a schematic illustration of a third embodiment of a housing body with a rotational element; and

FIG. 6 shows a schematic illustration of the arrangement of an energy recovery device in a feed line.

### DETAILED DESCRIPTION

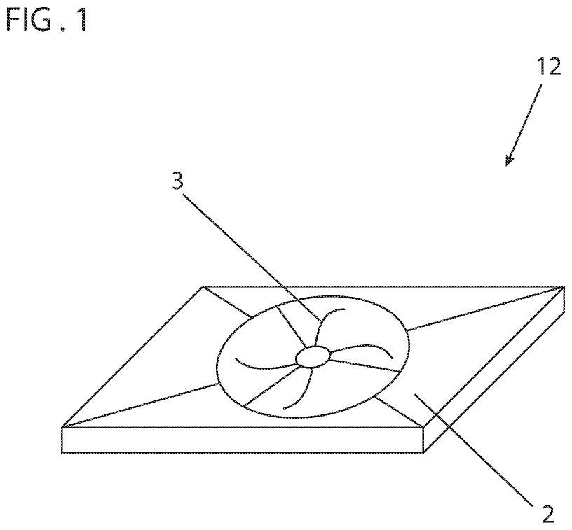

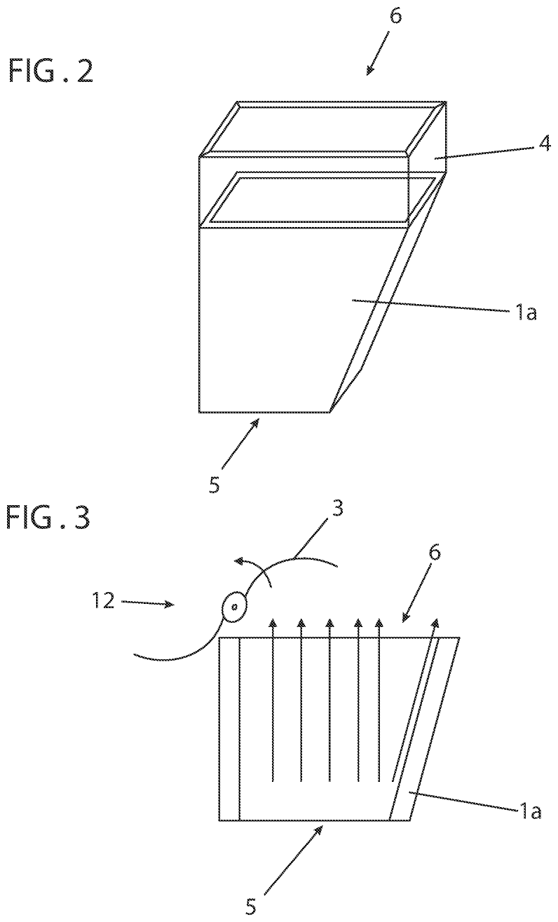

FIG. 1 shows a schematic illustration of an energy recovery device 12 having a rotational element, which is arranged on a frame body 2 and is in the form of a blade wheel 3. The frame body 2 of the energy recovery device 12 can be arranged e.g. on a support frame 4 of a housing body 1a (this housing body is shown in FIG. 2). The housing body 1a can be connected, by a housing inlet 5, to an exhaust air line (not shown here) of a unit (not shown here either) through which air flows. Proceeding from the housing inlet 5, the opening cross-section of the housing body 1a widens up to the housing outlet 6.

The housing body 1a acts as a diffuser because of its cross-section widening from the housing inlet 5 up to the housing outlet 6, and as a result the flow velocity of the air flowing through the housing body 1a is reduced and the static pressure is increased, so that the rotational element 3, which can be arranged in the region of the housing outlet 6 (see FIG. 3), can be driven particularly reliably. The rotational energy of the rotational element 3 is converted into electrical energy by a generator (not shown here) connected to the rotational element 3, and this electrical energy can be used in any way.

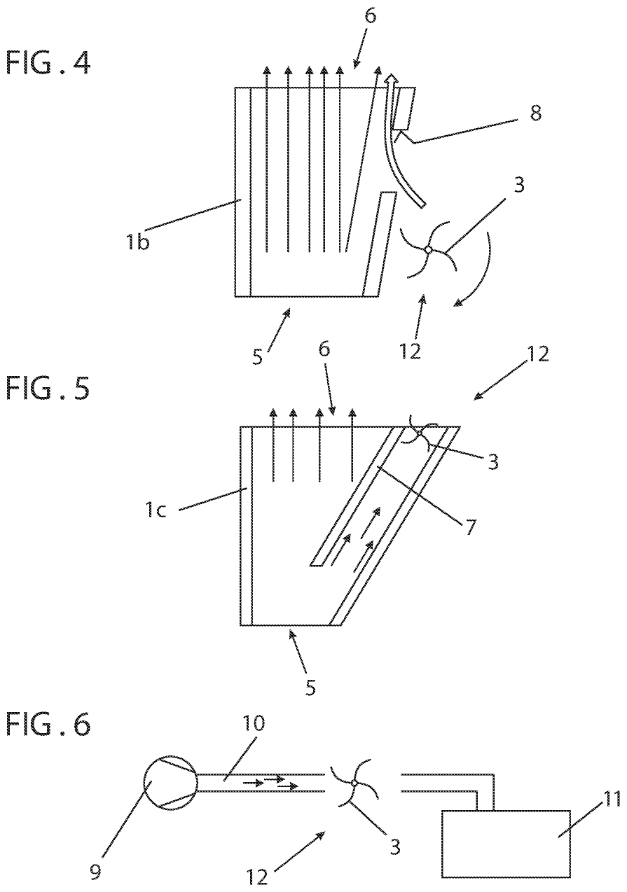

Another embodiment of a housing body 1b is shown in FIG. 4. In this embodiment, the housing body 1b has a lateral housing opening 8. The air flow flowing through the housing body 1b from the housing inlet 5 to the housing outlet 6 produces a suction flow outside of the housing body 1b in the region of the housing opening 8, and this suction flow drives a blade wheel 3 which is arranged there and which belongs to the energy recovery device 12.

In another embodiment of the housing body 1c, the housing body 1c has a guide plate 7, which extends from the housing outlet 6 toward the housing inlet 5. By the guide plate 7, part of the air flow flowing through the housing body 1c is split off and fed between the guide plate 7 and the housing wall of the energy recovery device 12 (see FIG. 5).

In the embodiment shown in FIG. 6, the blade wheel 3 of the energy recovery device 12 is arranged within a supply air line 10, which leads from a compressed-air source 9 to a unit 11 driven by the compressed air. The compressed-air source 9 can have, for example, a spiral housing, in the exit region of which the energy recovery device 12 is arranged.

### LIST OF REFERENCE SIGNS

1a, 1b, 1c Housing body
2 Frame body
3 Rotational element/blade wheel
4 Support frame
5 Housing entry
6 Housing exit
7 Guide plate
8 Housing opening
9 Compressed-air source
10 Supply air line
11 Unit
12 Energy recovery device

1. A textile machine comprising:
a plurality of workstations for processing fibres and/or threads and having at least one unit through which air flows, located centrally and/or at the individual workstations; and
an energy recovery device connected to a supply air line and/or an exhaust air line of the at least one unit and having a rotational element which can be driven by an air flow and which is connected to a generator for electricity generation.

2. The textile machine according to claim 1, wherein the energy recovery device comprises a housing body connected to the exhaust air line of the at least one unit and having a flow cross-section which widens from a housing inlet up to a housing outlet.

3. The textile machine according to claim 2, wherein the rotational element is arranged in a region of the housing outlet.

4. The textile machine according to claim 1, wherein an axis of rotation of the rotational element extends in a plane which is not oriented perpendicularly or parallel to a flow direction.

5. The textile machine according to claim 4, wherein the axis of rotation is arranged in such a way that the axis of rotation is oriented relative to the air flow independently or by control.

6. The textile machine according to claim 2, wherein the housing body has a guide plate which extends in a region between the housing inlet and the housing outlet and divides the air flow through the housing body, and the rotational element is arranged in a region between the guide plate and a housing wall.

7. The textile machine according to claim 2, wherein a housing wall has a housing opening and the rotational element is arranged on an outside of the housing body in a region of the housing opening in such a way that the air flow flowing through the housing body produces a suction flow which drives the rotational element.

8. The textile machine according to claim 1, wherein the energy recovery device is designed to be integrated into a supply air line.

9. The textile machine according to claim 1, wherein the energy recovery device is arranged in a region of an outlet of a compressed-air-generating device.

10. The textile machine according to claim 1, wherein the supply air line and/or the exhaust air line which belongs to the at least one unit and in which the energy recovery device is arranged comprises a duct extending in a longitudinal direction of the textile machine.

11. The textile machine according to claim 1, wherein the energy recovery device is designed to be integrated into a compressed air line leading to the at least one unit.

12. The textile machine according to claim 1, wherein the energy recovery device is arranged in a region of an outlet of a spiral housing of a compressed-air-generating fan wheel.
